(19) United States
(12) Patent Application Publication
(10) Pub. No.: US 2011/0010085 A1
(43) Pub. Date: Jan. 13, 2011

(54) Navigation device, program for the same and method for indicating information of the same

(75) Inventor: Hiroshi Tanaka, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/801,139

(22) Filed: May 25, 2010

(30) Foreign Application Priority Data
Jul. 7, 2009 (JP) 2009-160947

(51) Int. Cl. G01C 21/00

(52) U.S. Cl. 701/201; 701/204

(57) ABSTRACT

A destination setting unit is configured to set a destination on a map. A time setting unit is configured to set a target time by which a user should arrive at the destination. A specifying unit is configured to associate an intermediate point, which is on a path to the destination, with a departure time, by which the user should leave the intermediate point so as to arrive at the destination by the target time. The specifying unit is further configured to specify the associated intermediate point and the departure time. An indication unit is configured to indicate the associated intermediate point and the departure time on a display device such that the user can recognize a correspondence between the associated intermediate point and the departure time.

### CROSS REFERENCE TO RELATED APPLICATIONS

This application is based on and incorporates herein by reference Japanese Patent Application No. 2009-160947 filed on Jul. 7, 2009.

### FIELD OF THE INVENTION

The present invention relates to a navigation device configured to indicate a map. The present invention further relates to a program for the navigation device. The present invention further relates to a method for indicating information of the navigation device.

### BACKGROUND OF THE INVENTION

For example, JP-A-11-16094 discloses a conventional art related to indication of a place on a map so as to notify information of the place where a movable object in the present position can reach within a predetermined time period. For example, the art of JP-A-11-16094 is used for a car allocation system of a taxi company or a security company. Specifically, the present system is configured to indicate the present position of a taxi vehicle or a security vehicle and a place where the vehicle can reach from the present position in a predetermined period on the map.

According to the art of JP-A-11-16094, such a system can visually recognize a possibility whether a vehicle can reach an arbitrarily set place or not without any instructions of a route search performed by setting a destination. Thus, such a system can instruct an optimal allocation of a vehicle to a taxi vehicle or a security vehicle. When the prior art of JP-A-11-16094 is applied to a navigation device, a user can be notified of a place where the user leaving the present position can possibly reach within a predetermined time period. Nevertheless, in such a system, when a user needs to reach a destination by a target time, the user cannot be notified of an intermediate place where the user should reach by an intermediate time. In such a system, the user can know a place where the user can arrive within one hour. However, for example, in a case where the destination is a hotel, and a user prefers to arrive at the hotel by 3:00 p.m. (check-in time), the user cannot immediately know an intermediate place where the user should arrive and a time by which the user should arrive at the intermediate place. Specifically, for example, in such a system, the user cannot immediately know an intermediate place where the user should path thorough and a time by which the user should path through the intermediate place to arrive at a hotel by 3:00 p.m.

### SUMMARY OF THE INVENTION

In view of the foregoing and other problems, it is an object of the present invention to produce a navigation device, by which a user, can immediately know, in order to arrive at a destination by a target time, an intermediate place and an intermediate time, by which the user should arrive at the intermediate place. It is another object of the present invention to produce a program for the navigation device. It is another object of the present invention to produce a method for indicating information of the navigation device.

According to one aspect of the present invention, a navigation device comprises a destination setting unit configured to set a destination on a map. The navigation device further comprises a time setting unit configured to set a target time by which a user should arrive at the destination. The navigation device further comprises a specifying unit configured to associate an intermediate point, which is on a path to the destination, with a departure time, by which the user should leave the intermediate point so as to arrive at the destination by the target time, and configured to specify the associated intermediate point and departure time. The navigation device further comprises an indication unit configured to indicate the associated intermediate point and departure time on a display device such that the user can recognize a correspondence between the associated intermediate point and departure time.

According to another aspect of the present invention, a method for indicating information of a navigation device, the method comprises setting a destination on a map. The method further comprises setting a target time by which a user should arrive at the destination. The method further comprises associating an intermediate point, which is on a path to the destination, with a departure time, by which the user should leave the intermediate point so as to arrive at the destination by the target time. The method further comprises indicating the associated intermediate point and departure time on a display device such that the user can recognize a correspondence between the associated intermediate point and departure time.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an entire system including a navigation device according to an embodiment;

FIG. 2 is a flow chart showing a departure time contour drawing operation executed by a control unit of the navigation device;

FIG. 3 is an explanatory view showing departure time contours drawn on a map in the departure time contour drawing operation;

FIG. 4 is an explanatory view showing an indication mode when a time interval between departure time contours is set to be small near a target time;

FIG. 5 is an explanatory view showing a case where departure time contours are drawn in a case where an on-root place is set; and

FIG. 6 is a flow chart showing an arrival-impossibility notification operation executed by the control unit of the navigation device.

### DETAILED DESCRIPTION OF PREFERRED EMBODIMENTS

As follows, an embodiment will be described with reference to drawings.

### (1) Configuration

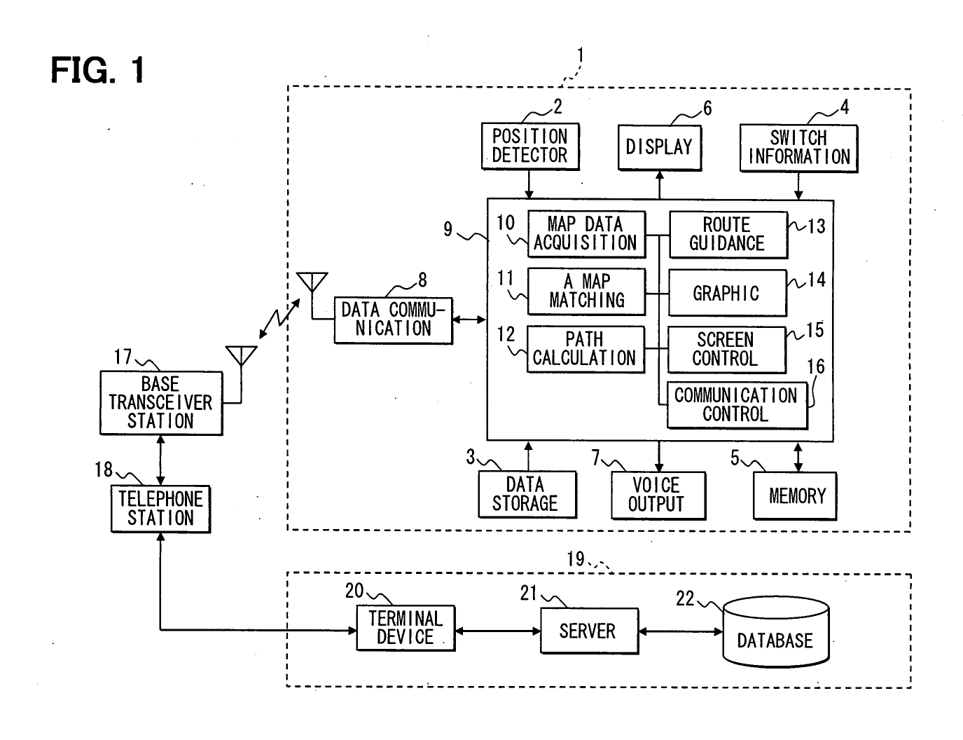

FIG. 1 is a block diagram showing an entire system including a navigation device 1 according to the present embodiment. The navigation device 1 is a generally-known electronic equipment mounted in a vehicle. The navigation device 1 is configured to search a path from the present position to a destination, configured to show the searched path on a map, and configured to show the present position on the searched path on the map. The navigation device 1 includes components such as a position detector unit 2, a map data storage unit 3, a switch information input unit 4, a memory 5, a display unit 6, a voice output unit 7, and a data communication unit 8. The navigation device 1 further includes a control unit 9 connected to the components of the navigation device 1.

The position detector unit 2 includes sensors for detecting the present position of the navigation device 1. The position detector unit 2 is a GPS receiver for a global positioning system (GPS) and configured to detect the present position of the vehicle based on signals from a generally-known geomagnetism sensor, a gyroscope, a distance sensor, and an electric wave from a GPS satellite (none shown). The multiple sensors respectively have errors different in characters. Therefore, the multiple sensors are configured to compensate the errors so as to enhance a detection accuracy. The position detector unit 2 may be configured of a part of the multiple sensors. The position detector unit 2 may include a rotation sensor of a steering wheel, a vehicle sensor of each wheel, and the like. The map data storage unit 3 is a storage device configured of a CD-ROM or a DVD-ROM, a memory card, a hard disk drive (HDD), and the like. The map data storage unit 3 is configured to store various data such as map matching data for enhancing a position detection accuracy, map data, and landmark data.

The switch information input unit 4 is a touch sensor, a mechanical switch, or the like integrated with the display unit 6. The switch information input unit 4 is configured to instruct an operation of various functions to the control unit 9 according to a switch operation of a user. The instructed function includes, for example, a map scale change, a menu indication selection, a destination set, a target time set, a course place set, a departure time contour indication, a route search, a route guidance start, a present position correction, a display screen change, a volume control, and/or the like. The switch information input unit 4 may be configured of a remote control terminal to perform transmission and reception of information with the control unit 9 via wireless communications.

The memory 5 is a storage device configured of, for example, a ROM and a RAM. The program of the navigation is stored in the ROM. The RAM is configured to function as a work memory of the program and configured to temporarily store the map data obtained from the map data storage unit 3 and the like. The display unit 6 is a display device configured to indicate a map, a destination select screen, and the like for performing the navigation operation. The display unit 6 is capable of full color indication and may be configured of a liquid crystal display, an organic electroluminescence display, or the like.

The voice output unit 7 is, for example, a speaker configured to output a music, a voice, and the like to the outside. The voice output unit 7 is further configured to output a voice for a guidance and an instruction for operating the screen. The data communication unit 8 is an interface having an intercommunication function. The data communication unit 8 is configured of, for example, a personal digital assistant, such as a cellular phone and/or a car telephone. The data communication unit 8 is easily removable from the control unit 9. The data communication unit 8 may be combined with the control unit 9 such that the data communication unit 8 is hardly detached from and attached to the control unit 9.

The control unit 9 is an electronic control unit configured to perform various kinds of operations and shown by functional blocks. The control unit 9 functions as a map data acquisition unit 10, a map matching unit 11, a path calculation unit 12, a route guidance unit 13, a graphic unit 14, a screen control unit 15, and a communication control unit 16. In the present embodiment, the processing units of the control unit 9 are configured of an integrated software system. The processing units 10 to 16 of the control unit 9 may be configured of software as exemplified in the present embodiment or may be partially or entirely configured of discrete hardware devices such as electronic circuits.

The map data acquisition unit 10 is configured to obtain the map data required by the processing units 11 to 16 from the map data storage unit 3 and configured to provide the obtained map date to the processing units 11 to 16. The operations are performed by using the ROM and the RAM of the memory 5.

The map matching unit 11 is configured to specify a road, on which the present position exists, based on position information obtained by the position detector unit 2, road geometry data of the map data obtained from the map, data storage unit 3, and/or the like. In the present operation, the map data acquisition unit 10 obtains required map data from the map data storage unit 3. The path calculation unit 12 is configured to calculate a path to the destination according to information on the present position calculated by the map matching unit 11, the destination set by a user using the switch information input unit 4, and or the like. In particular, according to the present embodiment, the path calculation unit 12 is configured to specify an intermediate point and a departure time on a path to the destination so as to calculate a departure time contour.

The route guidance unit 13 is configured to calculate information items required for the guidance based on a result of the path calculation, shape data of a road stored in the map data, position information on an intersection, position information on a railroad crossing, and the like. The route guidance unit 13 is configured to calculate a guidance needed for a driver, such as whether the vehicle turns to the right or the left, and the like. The graphic unit 14 is configured to generate an image of the present position, an image of a destination, the departure time contour, which is for determination to arrive at the destination at a target time, and the like on the map. The graphic unit 14 is further configured to generate a schematic image of a highway, an enlarged image around an intersection when the vehicle is close to the intersection, and the like, according to an instruction of the screen control unit 15 and configured to indicate the generated images on the display unit 6. The screen control unit 15 is configured to send an instruction of information, which is to be indicated on the display unit 6, to the graphic unit 14. The communication control unit 16 is configured to transmit an instruction inputted by a user using the switch information input unit 4 and an instruction at a regular interval to the data communication unit 8 and configured to enable intercommunication with the data communication unit 8.

The navigation device 1 is further configured to obtain external traffic information and external weather information. Specifically, the data communication unit 8 of the navigation device 1 is configured to communicate with an external base transceiver station 17 via wireless communications. Thereby, the data communication unit 8 is configured to receive traffic information and weather information sent from a traffic and weather information center 19, which controls and sends the traffic information and the weather information, via a telephone station 18. The traffic and weather information center 19 includes a terminal device 20 for communicating with an exterior device, a server 21 for modifying the traffic information and the weather information, and a database 22 for accumulating the traffic information and the weather information.

### (2) Operation

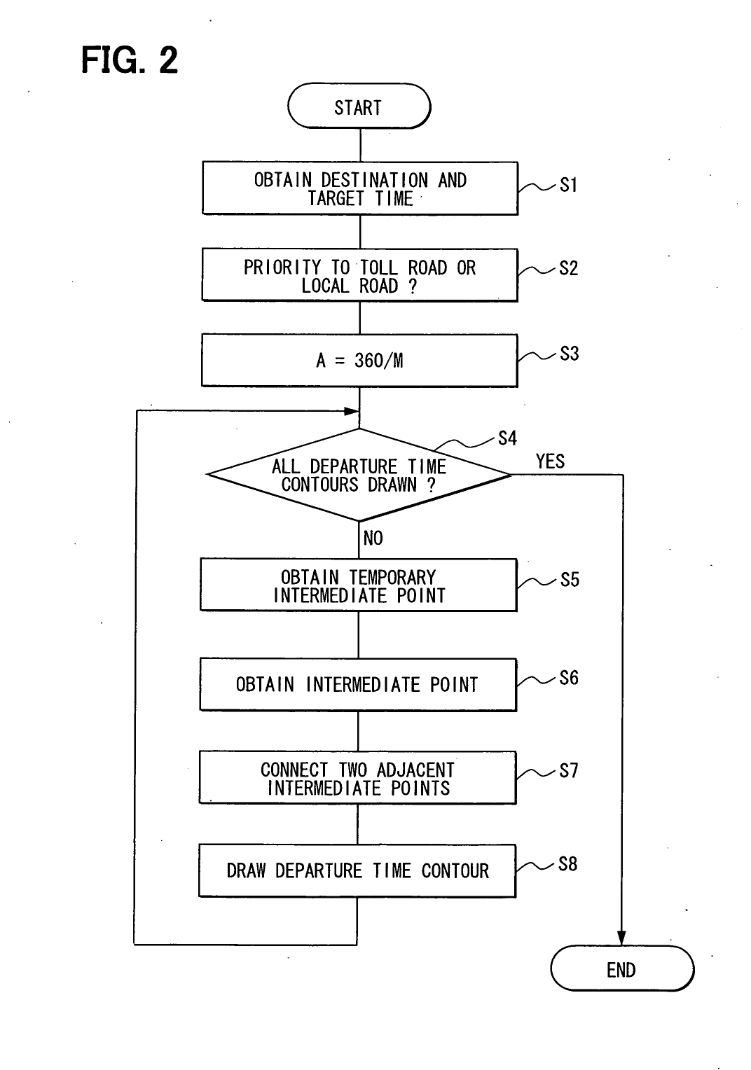

As follows, an operation of the control unit 9 of the navigation device 1 will be described. FIG. 2 is a flow chart showing an operation executed by the control unit 9 for generating the departure time contour.

When a user activates an ignition device of the vehicle, the navigation device 1 is activated. The data communication unit 8 of the navigation device 1 is configured to access the traffic and weather information center 19 via an external wireless-communication base station 17 and the telephone station 18 and is configured to obtain the traffic information and the weather information accumulated in the database 22. When a user manipulates the switch information input unit 4 to set the navigation device 1 in a departure time contour drawing mode, the control unit 9 performs a departure time contour drawing operation.

At S1, the destination and the target time inputted by a user by manipulating the switch information input unit 4 are obtained, and the processing proceeds to S2. At S2, a search condition, which is inputted by a user by manipulating the switch information input unit 4, is obtained. The search condition includes road selection information on whether a priority is given to a toll road or a local road. Thus, the processing proceeds to S3. At S3, a preparation for performing a route searching in all directions (360 degrees) centering on the destination is made, in order to draw the departure time contour at an interval of a predetermined unit time such as 1 hour. Specifically, a predetermined search direction number m (for example, 16) is obtained, and an angle A is calculated as a unit for performing the route searching from a formula of A=(360/m). For example, when the value of the search direction number m is 16, A=22.5 degrees is obtained. The processing proceeds to S4 subsequent to the processing of S3. At S4 to S8, an operation is performed for calculating an intermediate point and a departure time to draw a departure time contour. In the present operation, one departure time contour is drawn by performing a single operation of S4 to S8. That is, when the number of the departure time contours to be drawn is n, the operation of S4 to S8 is repeated for n times.

For example, the number n of the departure time contours to be drawn may be calculated by adding a predetermined number such as 1 to a number, which is obtained by dividing a time period between the present time and the target time by a time interval of the departure time contours to be drawn. The number n of the departure time contours to be drawn may be a maximum number of departure time contours, which can be indicated within the screen. The number of the departure time contours, which have been drawn, is specified by a counter value N. The counter value N is set to 0 in an initial state.

At S4, it is determined whether all the departure time contours of the number n are drawn. When all the departure time contours are not drawn, S4 makes a negative determination, and the processing proceeds to S5. Alternatively, when all the departure time contours are drawn, S4 makes a positive determination. In this case, the departure time contour drawing operation is terminated. The determination can be made by determining whether the number n of the departure time contours, which are to be drawn, is equal to the number N of the departure time contours, which have been already drawn.

At S5, a departure time, which corresponds to a departure time contour to be drawn, is calculated. Further, a temporary intermediate point is set for specifying an intermediate point, which corresponds to the departure time. The temporary intermediate point is determined by dividing a circle centered on the destination by the constant angle A. The processing proceeds to S6 subsequent to the processing of S5. Specifically, at S6, a departure time corresponding to a departure time contour drawn in the operations of S4 to S8 is first calculated. For example, the departure time may be calculated in the following manner, when the departure time contour corresponding to the departure time near the target time is drawn. First, a first value is calculated by adding 1 to the number N of the departure time contours, which have been already drawn. Second, a second value is calculated by multiplying the first value with an interval (such as 1 hour) of the departure time contours to be drawn. Third, the departure time is calculated by subtracting the second value from the target time.

The temporary intermediate point is set at a regular interval of the angle A on a circle centering on the destination. In this case, the radius is set centering on the destination so as to include all the intermediate points corresponding the departure time. The radius is a value experimentally determined based on the area and the required time. Next, an example of determination of the radius of the circle will be described. In this example, the target time, at which the vehicle should arrive at the destination, is 19:00, and a departure time contour corresponding to 18:00 is to be drawn. The radius of the circle is set to correspond to a time before 18:00 in consideration of a subsequent calculation. That is, on the premise of the departure time set to 18:00, the corresponding intermediate point is calculated. Therefore, the temporary intermediate point is set to the outside of the intermediate point. That is, the temporary intermediate point is set to a position distant from the destination.

At S6, a path from each temporary intermediate point to the destination is calculated. Further, an intermediate point, from which a predetermined time is required to arrive at the destination, is obtained. Thus, at S6, an intermediate point for drawing the departure time contour is specified. Subsequently, the processing proceeds to S7. Specifically, a path from the temporary intermediate point to the destination is searched in consideration of traffic information, weather information, a link cost of the road, and the like. The intermediate point corresponding to the departure time is specified on the path by performing an inverse calculation from the destination. Thus, the intermediate point is set for drawing the departure time contour. In the present processing, the intermediate point is specified according to the distance to the destination, the traveling speed of the vehicle, and the like, in synthetically consideration of various situations affecting to arrival of the vehicle at the target time.

In the present processing, as the search direction number m becomes large, a precision of the departure time contour is enhanced. However, as the search direction number m becomes large, a large computation time is required. At S7, two adjacent points of the intermediate points specified at S6 are connected with each other. Subsequently, the processing proceeds to S8. At S8, the departure time contour generated by connecting the intermediate points is drawn. Thus, the processing returns to S4. At this time, the counter value N indicating the number of the departure time contours, which have been already drawn, is incremented by one.

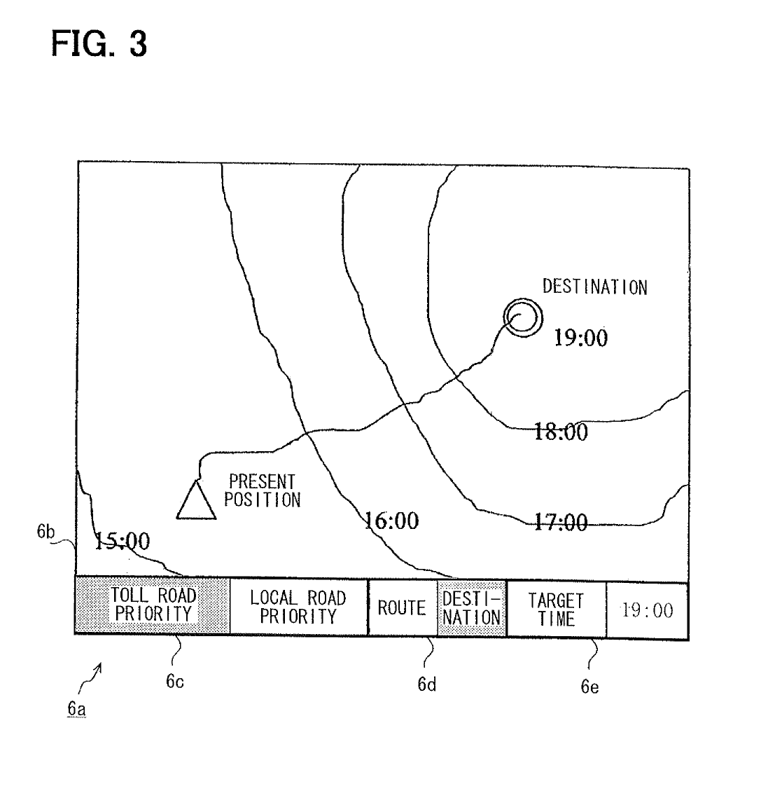

FIG. 3 shows an indicated screen 6a on the display unit 6. The indicated screen 6a is generated by the departure time contour drawing operation executed by the control unit 9. The indicated screen 6a includes a map indication 6b, a road selection indication 6c, an on-root place/destination indication 6d, and a target time indication 6e. The map indication 6b includes a specified present position and a specified destination. FIG. 3 shows an example in which a user wants to arrive at the destination shown by a double circle at a target time of 19:00. A searched path from the present position shown by a triangle is indicated in the screen. In addition, a departure time contour of 18:00, a departure time contour of 17:00, a departure time contour of 16:00, and a departure time contour of 15:00 are drawn in the screen.

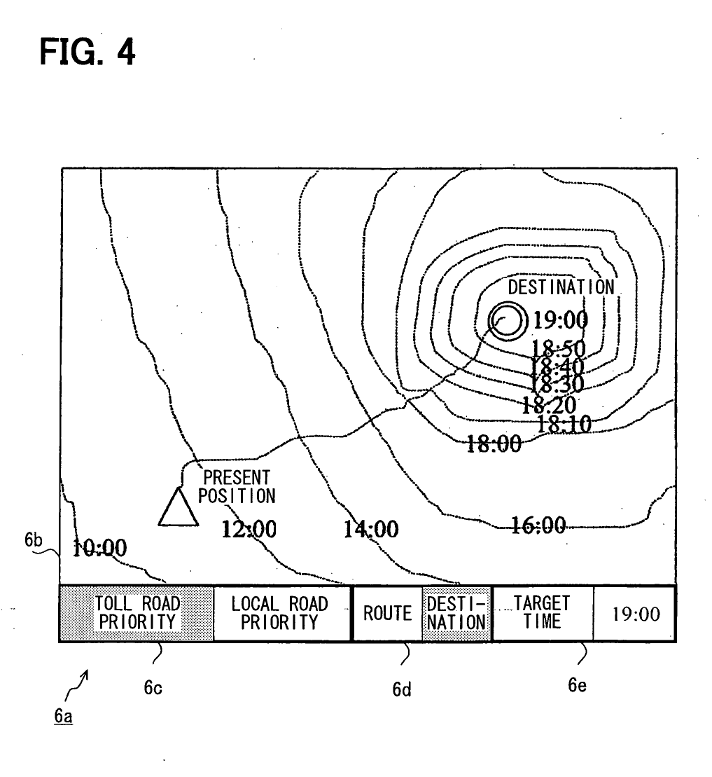

Each departure time contour shows that the user arrives at the destination at the target time, when leaving the corresponding point at the indicated time. An example have been described with reference to FIGS. 2, 3, on the premise of a mode in which departure time contours are drawn at a regular interval. It is noted that another mode may be selected according to an operation of a user. Specifically, in another mode shown in FIG. 4, the departure time contours near the target time are finely indicated at a short interval compared with the departure time contours distant from the target time. Even in this mode, the same or equivalent operation as described above may be performed.

The road selection indication 6c shows whether a toll road is selected with a priority by a user or a local road is selected with a priority by a user. The road selection indication 6c relates to the processing of S2 of FIG. 2. In the present example of FIG. 3, a toll road is selected with a priority. The on-root place/destination indication 6d shows whether the currently indicated departure time contour is related to the destination or the currently indicated departure time contour is related to an on-root place. In the present example of FIG. 3, the currently indicated departure time contour is related to the destination. The target time indication 6e shows a target time set by a user. The target time indication 6e relates to the processing of S1 of FIG. 2. In the present example of FIG. 3, the target time is set to 19:00.

Similarly, FIG. 4 shows the indicated screen 6a on the display unit 6. In the example of FIG. 4, the departure time contours near the target time are finely, indicated at a short interval compared with the departure time contours distant from the target time. Specifically, the target time is set to 19:00. The departure time contours are drawn at an interval of 10 minutes in the time range between 18:00 and 19:00 near the target time. In another time range distant from the target time, the departure time contours are drawn at an interval of 2 hours.

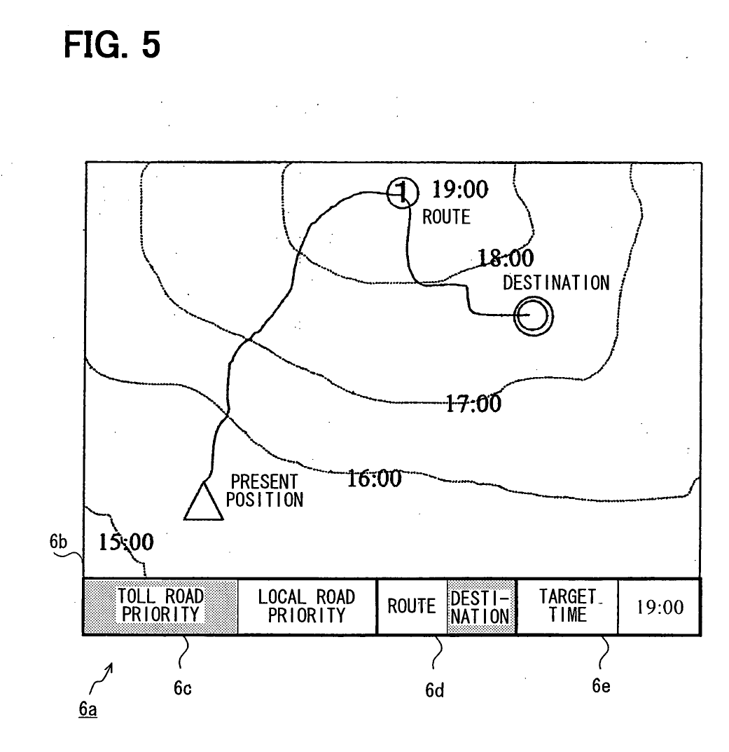

Similarly, FIG. 5 shows the indicated screen 6a on the display unit 6. In the present example of FIG. 5, the on-root place/destination indication 6d is set to an on-root place. Similarly to the destination, the departure time contour can be indicated on the on-root place on the way to the destination.

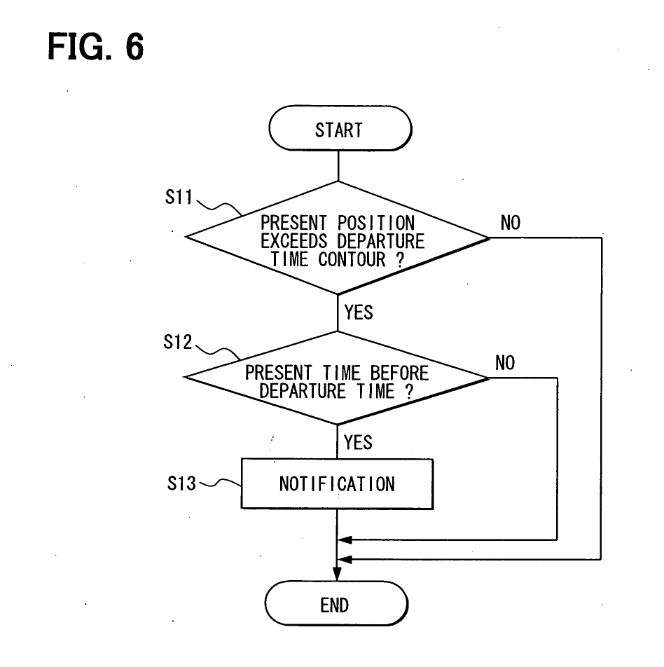

Next, an arrival-impossibility notification operation will be described with reference to a flow chart of FIG. 6. FIG. 6 shows the flow chart of the arrival-impossibility notification operation executed by the control unit 9 of the navigation device 1. The navigation device 1 executes the departure time contour drawing operation shown in FIG. 2. The navigation device 1 executes the departure time contour drawing operation in a condition where departure time contours are drawn in, for example, FIGS. 3 to 4 at a predetermined interval such as several seconds.

At S11, it is first determined whether the present position calculated by the map matching unit 11 newly exceeds a departure time contour to the destination. When the present position newly exceeds a departure time contour, S11 makes a positive determination, and the processing proceeds to S12. When the present position does not newly exceed a departure time contour, S11 makes a negative determination, and the present departure time contour drawing operation is terminated. At S12, it is determined whether the present time is before or after a departure time corresponding to the departure time contour, which the present position is determined to have newly exceeded at S11. When the present time is after the departure time corresponding to the departure time contour, S12 makes a positive determination, and the processing proceeds to S13. When the present time is not after the departure time corresponding to the departure time contour, S12 makes a negative determination, and the present arrival-impossibility notification operation is terminated. At S13, a user is notified that the user cannot arrive at the destination by a target time, and the present arrival-impossibility notification operation is terminated. The notification to the user is performed by, for example, indication on the display unit 6 and a voice output by the voice output unit 7.

### (3) Effect

As described above, according to the navigation device 1 of the present embodiment, the intermediate point on the path to the destination and the departure time, at which a user should pass the intermediate point in order to arrive at the destination by the target time, are specified and associated with each other. Further, the associated the intermediate point and the departure time are indicated on the display unit 6 (FIGS. 3, 4). Therefore, a user can be notified immediately and visually when the user should pass a specific point. Further, multiple intermediate points, which are associated with the same departure time, are connected with the line to form the departure time contour. Therefore, without looking for a point on the map, a user can be visually notified by the departure time contour when the user should pass (leave) a specific point.

Further, in the mode of FIG. 3, the departure time contours are drawn at the same interval such as 1 hour. In the present mode, the user can be notified of the departure time according to the number of the departure time contours from the destination. Therefore, the user can further visually obtain information of the departure time.

On the other hand, in the mode of FIG. 4, the departure time contours near the target time are finely indicated at a short interval, compared with the departure time contours distant from the target time. Therefore, in a case where i) it is not necessary to know the departure time strictly in the intermediate point corresponding to a departure time distant from the target time, and ii) it is necessary to know the departure time strictly in the intermediate point corresponding to a departure time near the target time so as to timely arrive at the destination, the user can further strictly confirm a departure time by which the user should pass through the point corresponding to the departure time near the target time. Thus, convenience of the present system can be further enhanced.

Further, when it is determined that a user cannot arrive at a destination by a target time, the user can be notified of the condition by indication on the display unit 6 and a voice output by the voice output unit 7. Therefore, the user can know the condition, where the user cannot arrive at the destination by the target time, when it is determined that the condition is made. Thus, it is convenient to reconsider the schedule. Further, the temporary intermediate points are set in, for example, 16 directions, and the intermediate points are specified, and thereby the departure time contours are drawn. Therefore, a user can visually know an intermediate point, which the user can pass through in order to arrive at the destination by the target time.

### (4) Correspondence

The step S1 executed by the control unit 9 may be equivalent to a destination setting unit. The step S1 executed by the control unit 9 is also equivalent to a time setting unit. The step S6 executed by the control unit 9 may be equivalent to a specifying unit. The step S8 executed by the control unit 9 may be equivalent to an indication unit. The steps S11 and S12 executed by the control unit 9 are equivalent to a determination unit. The step S13 executed by the control unit 9 are equivalent to a notification unit.

### (5) Other Embodiments

The embodiments have been described above. The present invention is not limited to the above-described embodiments, and may be practiced in various forms. In the above embodiments, a possibility whether a user can arrive at the destination by the target time is determined by comparing the departure time with the present time when the present position exceeds a departure time contour. Alternatively, instead of S11, it may be determined whether the present time exceeds a departure time corresponding to the next departure time contour. When it is determined that the present time exceeds the departure time corresponding to the next departure time contour, it may be determined whether the present position is near the destination beyond the departure time contour, instead of S12. That is, it may be determined whether the present position is near the needed intermediate point.

In the above embodiments, multiple departure time contours are drawn on the map at one-hour interval. The unit time is not limited to one hour. Alternatively, the unit time may be changed to a day, an hour, a minute, and a second, according to a set target time.

In the above embodiments, a line is drawn to form the departure time contour. The departure time contour is not limited to be formed by a line. The departure time contour or an equivalent object may be specified in another way. For example, singular or multiple departure time(s) may be indicated on the route by a point or multiple points each including an icon or the like. In this case, the route need not be indicated. When the singular or multiple departure time(s) are indicated on the route by a point or multiple points, the departure time(s) may be indicated by a number and may be indicated with different colors.

In the above embodiments, the departure time contours are used for indication. Alternatively, for example, the distance along the way may be indicated by a number such as “remaining 40 km”, and the like. Alternatively, for example, a linear distance to the destination may be indicated by a number.

Summarizing the above embodiments, a navigation device includes a destination setting unit, a time setting unit, a specifying unit, and an indication unit. The destination setting unit is configured to set a destination on a map. The time setting unit is configured to set a target time, by which a user should arrive at the destination. The specifying unit is configured to associate an intermediate point on a path to the destination and a departure time by which a user should leave the intermediate point in order to arrive at the destination at a target time and configured to specify the associated intermediate point and the target time. The indication unit is configured to indicate the intermediate point and the departure time associated with the intermediate point on a display device such that the user can recognize the correspondence therebetween.

The intermediate point on the path to the destination need not be on a shortest path to the destination and may include a point on a path viewed from the destination in all the directions. Specifically, the intermediate point may be a point, through which a user may pass when detouring. In addition, the intermediate point may be a point, through which a user less possibly passes actually to arrive at the destination, as long as the point is on a path to the destination. The intermediate point may be indicated with a point. Alternatively, the intermediate, point may be indicated with, for example, an icon, a number, a sign, and the like to indicate a correspondence with the departure time.

The navigation device is configured to associate the intermediate point on the path to the destination and the departure time, at which a user should pass the intermediate point in order to arrive at the destination by the target time, and specify the intermediate point and the departure time. Further, the associated the intermediate point and the departure time are indicated on the display unit. Therefore, a user can immediately and visually know when the user should pass a specific intermediate point.

When the intermediate point is not simply indicated by multiple points but indicated by a line, which is formed by connecting multiple points, a user need not to look for the intermediate point on the map. Thus, the intermediate point can be further easily found. Therefore, the indication unit may be configured to indicate the departure time contour formed by connecting multiple intermediate points, which are associated with the same departure time, with a line. In the navigation device, multiple intermediate points, which are associated with the same departure time, may be connected with the line to form the departure time contour. Therefore, without looking for a point on the map, a user can be visually notified by the departure time contour when the user should pass (leave) a specific point.

When a time interval between the departure time contours is constant, a user can know a departure time according to the number of the departure time contours from the destination. Thus, the user can further easily obtain information of the departure time. Therefore, the indication unit may be configured to indicate multiple departure time contours at a constant time interval. Specifically, the present navigation device may be configured to indicate the departure time contours at the constant interval such as 1 hour, 10 minutes, or 30 minutes, for example. Therefore, a user can know the departure time according to the number of the departure time contours from the destination. Thus, the user can further easily and visually obtain information.

Alternatively, the following case may be conceived: i) a user need not to know a departure time strictly in an intermediate point corresponding to a departure time distant from the target time; and ii) the user needs to know a departure time strictly in an intermediate point corresponding to a departure time near the target time so as to timely arrive at the destination. In consideration of such a case, the indication unit may be configured to indicate multiple departure time contours at multiple different time intervals. Furthermore, for all the departure time contours, a time interval between two of the multiple departure time contours near the target time is set to be less than a time interval between two of the multiple departure time contours distant from the target time. In this case, the time interval between the adjacent departure time contours may be entirely differently set, to, for example, 10 minutes, 20 minutes, 30 minutes, and the like, as being distant from the target time. Alternatively, the time interval between the adjacent departure time contours may be partially differently set to, for example, 10 minutes, 10 minutes, 10 minutes, 30 minutes, 30 minutes, 30 minutes, and the like, as being distant from the target time. That is, in this case, the came time intervals may be changed stepwise, such that the same time intervals may exist. With the navigation device, a user can further strictly confirm the time, when the user should leave, at a position corresponding to a departure time near the target time, and it is convenient for the user.

Further, when it is determined that a user cannot arrive at the destination by the target time, it is convenient for the user since being notified of the determination so as to quickly reconsider a schedule. In consideration of such a case, the navigation device may further include a determination unit and a notification unit. The determination unit may be configured to determine a possibility that a user can arrive at the destination by a target time, by respectively comparing a present position and a present time with a departure time contour and a departure time, which is associated with the departure time contour. When the determination unit determines that it is impossible to arrive at the destination by the target time, the notification unit is configured to notify a user of it. When it is determined that a user cannot arrive at the destination by the target time, it is convenient for the user since being notified of the determination so as to quickly reconsider a schedule consequently.

Further, when a user has a time margin with respect to a target time, the user need not simply move from the present position to the destination through a shortest path. In this case, the user may consider an intermediate point, which the user can pass through optionally. In consideration of such a case, the specifying unit may be configured to: set multiple temporary intermediate points at a regular, interval on a circle centering on the destination; search a path from the set multiple temporary intermediate points to the destination; and specify an intermediate point on the searched path and a departure time corresponding to the intermediate point. For example, the multiple temporary intermediate points may be set on the circle at the regular interval corresponding to directions such as 4 directions, 8 directions, and 16 directions. The navigation device can specify intermediate points from the destination evenly in different directions. Therefore, a user can visually know intermediate points through which the user can pass in order to arrive at the destination by the target time.

A program may be configured to let a computer to function as: a destination setting unit configured to set a destination on a map; a time setting unit configured to set a target time by which a user should arrive at the destination; a specifying unit configured to associate an intermediate point, which is on a path to the destination, with a departure time, by which a ser should leave the intermediate point so as to arrive at the destination by the target time, and configured to specify the associated intermediate point and the departure time; and an indication unit configured to indicate the intermediate point and the departure time associated with the intermediate point on a display device such that a user can recognize a correspondence.

The above structures of the embodiments can be combined as appropriate. The above processings such as calculations and determinations are not limited being executed by the control unit 9. The control unit may have various structures including the control unit 9 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A navigation device comprising:
a destination setting unit configured to set a destination on a map;
a time setting unit configured to set a target time by which a user should arrive at the destination;
a specifying unit configured to associate an intermediate point, which is on a path to the destination, with a departure time, by which the user should leave the intermediate point so as to arrive at the destination by the target time, and configured to specify the associated intermediate point and departure time; and
an indication unit configured to indicate the associated intermediate point and departure time on a display device such that the user can recognize a correspondence between the associated intermediate point and departure time.

2. The navigation device according to claim 1, wherein
the intermediate point includes a plurality of intermediate points, and
the indication unit is further configured to indicate a departure time contour formed by connecting the plurality of intermediate points, which are associated with a same departure time, with a line.

3. The navigation device according to claim 2, wherein
the departure time contour includes a plurality of departure time contours, and
the indication unit is further configured to indicate the plurality of departure time contours at a constant time interval.

4. The navigation device according to claim 2, wherein
the departure time contour includes a plurality of departure time contours,
the indication unit is further configured to indicate the plurality of departure time contours at a plurality of different time intervals, and
the indication unit is further configured to set a time interval between two of the plurality of departure time contours near the target time to be less than a time interval between two of the plurality of departure time contours distant from the target time.

5. The navigation device according to claim 1, further comprising:
a determination unit configured to compare a present position with a departure time contour and compare a present time with a departure time, which is associated with the departure time contour, to determine whether the user can arrive at the destination by the target time; and
a notification unit configured to perform a notification when the determination unit determines that the user cannot arrive at the destination by the target time.

6. The navigation device according to claim 1, wherein
the specifying unit is further configured to:
set a plurality of temporary intermediate points at a regular interval on a circle centering on the destination;
search a path from the set plurality of temporary intermediate points to the destination; and
specify an intermediate point on the searched path and a departure time corresponding to the specified intermediate point.

7. A program product comprising instructions being executed by a computer, the instructions including a method comprising:
a destination setting unit configured to set a destination on a map;
a time setting unit configured to set a target time by which a user should arrive at the destination;
a specifying unit configured to associate an intermediate point, which is on a path to the destination, with a departure time, by which the user should leave the intermediate point so as to arrive at the destination by the target time; and configured to specify the associated intermediate point and departure time; and
an indication unit configured to indicate the associated intermediate point and departure time on a display device such that the user can recognize a correspondence between the associated intermediate point and departure time.

8. A computer readable medium storing the program product according to claim 7.

9. A method for indicating information of a navigation device, the method comprising:
setting a destination on a map;
setting a target time by which a user should arrive at the destination;
associating an intermediate point, which is on a path to the destination, with a departure time, by which the user should leave the intermediate point so as to arrive at the destination by the target time; and
indicating the associated intermediate point and departure time on a display device such that the user can recognize a correspondence between the associated intermediate point and departure time.

10. A computer readable medium comprising instructions executed by a computer, the instructions including the method according to claim 9.
